(19) United States
(12) Patent Application Publication
(10) Pub. No.: US 2025/0388137 A1
(43) Pub. Date: Dec. 25, 2025

(54) VEHICLE SEAT AND METHOD OF TILTING THE SAME

(71) Applicant: HYUNDAI TRANSYS INC., Seosan-si (KR)

(72) Inventors: Gu Chang KANG, Hwaseong-si (KR); Sang In WOO, Hwaseong-si (KR); Ui Jeong LEE, Hwaseong-si (KR)

(21) Appl. No.: 19/238,344

(22) Filed: Jun. 13, 2025

(30) Foreign Application Priority Data
Jun. 21, 2024 (KR) 10-2024-0080812

(51) Int. Cl. B60N 2/18; B60N 2/10; B60N 2/427

(52) U.S. Cl. CPC B60N 2/1878; B60N 2/10; B60N 2/42763

(57) ABSTRACT

Disclosed is a vehicle seat including a seat unit on which a passenger is to be seated, a tilting unit assembled with the seat unit and configured to adjust an angle of the seat unit depending on a selection by a passenger, a control unit configured to transmit a control signal to the tilting unit and drive the tilting unit by the control signal, wherein the tilting unit includes air pouches and is configured to adjust the angle of the seat unit by allowing air to be injected into or exhausted from the air pouches by the control signal from the control unit.

### CROSS-REFERENCE TO RELATED APPLICATION

This application claims priority under 35 U.S.C. § 119(a) to Korean Patent Application No. 10-2024-0080812 filed on Jun. 21, 2024, the entire contents of which are incorporated herein by reference.

### BACKGROUND

### (a) Technical Field

The present disclosure relates to a vehicle seat and a method of tilting the same. More particularly, it relates to a vehicle seat and a method of tilting the same in which the front end of a seat cushion of a seat unit may be raised or lowered, the air pressure of a tilting unit in the left and right directions may be controlled depending on a degree of load due to a passenger's body, and reduction in the weight of the seat unit and reduction in a package size may be achieved through a simple coupling structure.

### (b) Background Art

In general, various convenience devices are installed on vehicle seats to help users maintain a more comfortable seating position.

In general, in addition to the basic configuration of vehicle seats, which include a seat cushion on which a passenger's lower body is seated, a backrest for supporting a passenger's upper body, and a headrest for supporting a passenger's neck and head, a seat mechanism that allows the passenger to implement free changes in posture depending on the passenger's body type and situation is being researched and developed.

Furthermore, in the case of seats of autonomous vehicles to be released in the future, a seat mechanism that enables implementation of a relaxed posture for resting and sleeping during long-distance driving is required.

However, in the case of existing vehicle seat cushions, there is a problem that a function of supporting the thighs of passengers is insufficient, and particularly, supporting force for the thighs of passengers with large bodies is insufficient, thus resulting in dissatisfaction with the comfort of a passenger's seating position.

The above-described vehicle seat employs a tilting device to support the lower body of the passenger more comfortably, and the tilting device is configured to be able to tilt the front part of a cushion upward.

FIG. 1 is a perspective view showing frames of a seat cushion and a seat back of a conventional vehicle seat from which fabric has been removed.

As shown in FIG. 1, a vehicle seat 10 includes a seat cushion frame 11 on which a passenger is to be seated, a seat back 12 that is rotated with respect to the seat cushion frame 11 as the angle of the seat back 12 is adjusted through a recliner 13, and a power tilt structure 3 provided in the front of the seat cushion frame 11.

Specifically, the recliner 13 installed on one side of the vehicle seat 10 is configured to adjust the angle of the seat back 12 with respect to the seat cushion frame 11, and is formed to have the power tilt structure 3 to adjust the height of the seat cushion frame 11.

Such a general tilting mechanism is configured in a way that adjusts the angle of the front end of a seat cushion by rotating a mechanical motor fixed within the vehicle seat 10. When a tilt switch is operated, gears connected to a motor rotates to move links mounted on the seat cushion frame 11, thus lifting the seat cushion.

However, the motor and frame structure for implementing this conventional seat tilting device has a problem that it occupies an excessive area of a package inside the seat and excessively increases the weight of the vehicle. Recently, as the electric vehicle industry has developed, attention has been focused on securing a battery space in the lower portion of the vehicle and improving energy efficiency, and this problem of the conventional technology may be seen as contrary to recent trends in the industry.

In addition, in order to lift the seat cushion, a number of link structures are operated through the motor, and in this process, interference between members may occur, and there is a disadvantage that workability is reduced due to the excessive number of parts.

In addition, among the conventional technologies, there is technology that lifts a seat cushion with a cylinder, but in order for the cylinder to properly support thighs, the cylinder requires a certain diameter or larger. Accordingly, the volume of the cylinder increases, and causes package performance and weight problems just like in the above-described motor.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with prior art, and it is an aspect of the present disclosure to provide a vehicle seat and a method of tilting the same that are suitable for the body shape of a passenger and provide a stable seating position to the passenger.

It is another aspect of the present disclosure to provide a vehicle seat and a method of tilting the same that reduce the number of parts compared to the structure of a motor driven to lift a seat cushion so as to reduce the weight of a vehicle.

It is yet another aspect of the present disclosure to provide a vehicle seat and a method of tilting the same that may improve workability by omitting a controller and wiring work for driving a motor.

It is a further aspect of the present disclosure to provide a vehicle seat and a method of tilting the same that may secure seat stability by operating a pneumatic system faster than a motor, and may prevent the submarine phenomenon of a passenger from occurring in the event of a vehicle crash.

The aspects of the present disclosure are not limited to the above-described aspects, and other aspects of the present disclosure that are not mentioned may be understood by the following description, and may be more clearly understood from the embodiments of the present disclosure. In addition, the aspects of the present disclosure may be realized by means and combinations thereof disclosed in the claims.

A vehicle seat for achieving the aspects of the present disclosure described above includes the following configuration.

In one aspect, the present disclosure provides a vehicle seat including a seat unit on which a passenger can be seated, a tilting unit assembled with the seat unit and configured to adjust an angle of the seat unit depending on a selection by a passenger, and a control unit configured to transmit a control signal to the tilting unit and drive the tilting unit by the control signal, wherein the tilting unit includes air pouches and is configured to adjust the angle of the seat unit by allowing air to be injected into or exhausted from the air pouches by the control signal from the control unit.

In a preferred embodiment, the air pouches may include an internal space so that air is supplied to or exhausted from the internal space, and may include at least a pair of air pouches facing one another.

In another preferred embodiment, the tilting unit may include a lever plate coupled to each of the air pouches such that an angle of the lever plate is adjustable depending on the inflation or deflation of a corresponding one of the air pouches, a bracket coupled to each of the air pouches and configured to support the inflation or deflation of a corresponding one of the air pouches, a cushion pipe configured such that one end of the bracket and one end of the lever plate are coupled to the cushion pipe, cushion tracks configured to be raised or lowered based on the air pouches being inflated or deflated, tilt plates assembled with the cushion pipe and configured to lift the seat unit, and a pump configured to supply air to the air pouches.

In still another preferred embodiment, the bracket may include bracket ribs including a continuous step formed inwardly to fix the corresponding one of the air pouches, and bracket holes configured to accommodate air hoses inserted into the bracket holes.

In yet another preferred embodiment, each of the air pouches may be coupled to one of a plurality of air hoses, and the plurality of air hoses extend between a corresponding one of the air pouches and the control unit serve as flow paths configured to inject or exhaust air into or from the corresponding one of the air pouches by the control signal from the control unit.

In still yet another preferred embodiment, each of the air hoses is coupled to a corresponding one of the air pouches so as to inject or exhaust air into or from the corresponding one of the air pouches.

In a further preferred embodiment, each of the air pouches may include air hose ribs configured to serve as guides configured to prevent the air hoses from being removed, a rubber member coupled to the cushion track to fix a path of the air hoses, and fasteners configured to fix the rubber member to the cushion track.

In another further preferred embodiment, holes may be formed in the air hose ribs, the air hoses are configured to be inserted into the holes, and the number of the holes may be based on a number of the air hoses.

In still another further preferred embodiment, the holes formed in the air hose ribs may be formed to have an area corresponding to a cross-sectional area of the air hoses.

In yet another further preferred embodiment, the air pouches may be capable of individually taking in and exhausting air so that an amount of air injected into an internal space of each of the air pouches is adjustable depending a desired degree of a passenger to control left-right balance of the seat unit.

A method of tilting a vehicle seat for achieving the aspects of the present disclosure described above includes the following configuration.

In another aspect, the present disclosure provides a method of tilting a vehicle seat cushion including inflating or deflating air pouches connected to air hoses, generating a reaction force between the air pouches and brackets based on the air pouches being inflated, changing an angle of lever plates coupled to a cushion pipe by inflating or deflating the air pouches, allowing tilt plates coupled to the cushion pipe to rotate in an opposite direction to an air intake direction of the air pouch so as to lift or lower cushion tracks, adjusting an angle of a front end of a seat unit by lifting or lowering the cushion tracks, performing a tilt-up or tilt-down operation of the front end of the seat unit, adjusting the angle of the front end of the seat unit such that an amount of air in the air pouches are determined and the angle of the front end is brought to a preferred angle of a passenger, and stopping injection or exhaust of air into the air pouches once the passenger is satisfied with an angle of the cushion tracks, and determining whether the angle of the cushion tracks has been adjusted to an angle within a set range and, returning to a step of inflating or deflating the air pouches in case the angle of the cushion tracks was not brought to an angle within the set range.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a perspective view showing frames of a seat cushion and a seat back of a conventional vehicle seat from which fabric has been removed;

FIG. 2(a) is a perspective view of a vehicle seat according to the present disclosure before operation, and FIG. 2(b) is a perspective view of the vehicle seat according to the present disclosure in a tilted state;

FIG. 3(a) is a perspective view of a tilting unit of the present disclosure before operation, and FIG. 3(b) is a perspective view of the tilting unit of the present disclosure in a tilted state;

FIG. 4 is a bottom perspective view showing the tilting unit of the present disclosure in the tilted state;

FIG. 5 is a perspective view illustrating in detail a state in which air pouches of the vehicle seat of the present disclosure are mounted on brackets;

FIG. 6 is a bottom view showing the vehicle seat of the present disclosure before operation;

FIG. 7(a) is a cross-sectional view taken along line A-A′ of FIG. 6, and FIG. 7(b) is a cross-sectional view taken along line B-B′ of FIG. 6;

FIG. 8 is a bottom view showing the vehicle seat of the present disclosure in the tilted state;

FIG. 9 is a cross-sectional view taken along line C-C′ of FIG. 8;

FIG. 10(a) is a view showing air hose ribs, and FIG. 10(b) is a view showing fasteners; and

FIG. 11 is a flowchart showing in detail a method of tilting the vehicle seat according to the present disclosure.

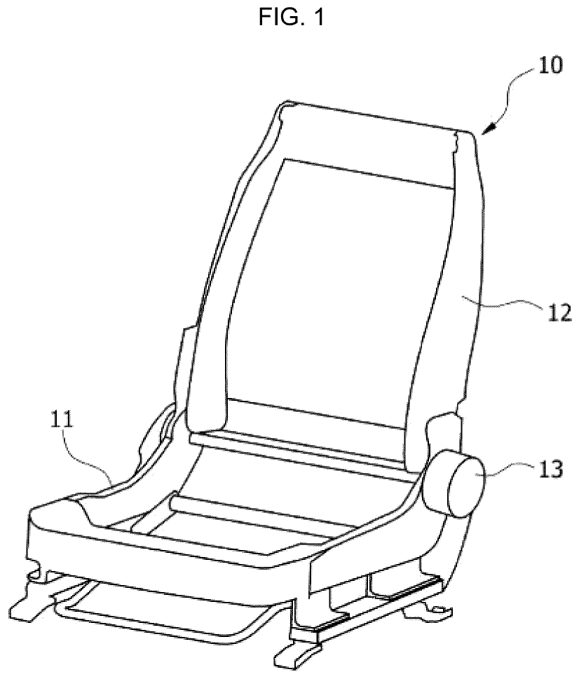

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. The present disclosure is not limited to the following embodiments, and the embodiments of the present disclosure may be implemented in various different forms. The embodiments are provided to make the description of the present disclosure thorough and to fully convey the scope of the present disclosure to those skilled in the art.

In addition, in the following description of the embodiments, it will be understood that the terms “ . . . part,” “ . . . unit,” “ . . . module,” etc. indicate units for processing at least one function or operation, and may be implemented as software, hardware, or a combination of software and hardware.

In addition, the terminology used herein is for the purpose of describing particular embodiments only and is not intended to be limiting. As used herein, singular expressions may be intended to include plural expressions as well, unless the context clearly indicates otherwise.

In addition, in the following description, terms, such as “first,” “second,” and the like, are used only to distinguish various elements having the same name, and do not imply a sequence or order unless clearly indicated by the context.

Hereinafter, the embodiments will be described in detail with reference to the accompanying drawings, and when describing with reference to the accompanying drawings, the same reference numerals are given to identical or corresponding components, and redundant descriptions thereof will be omitted.

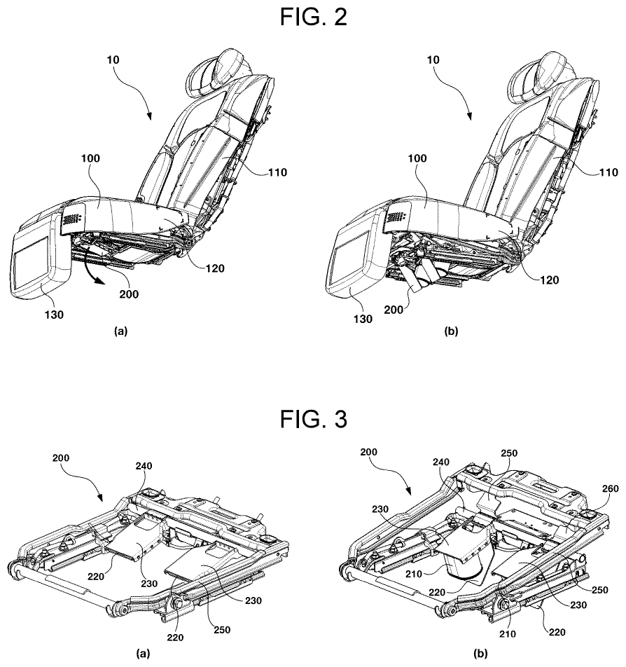

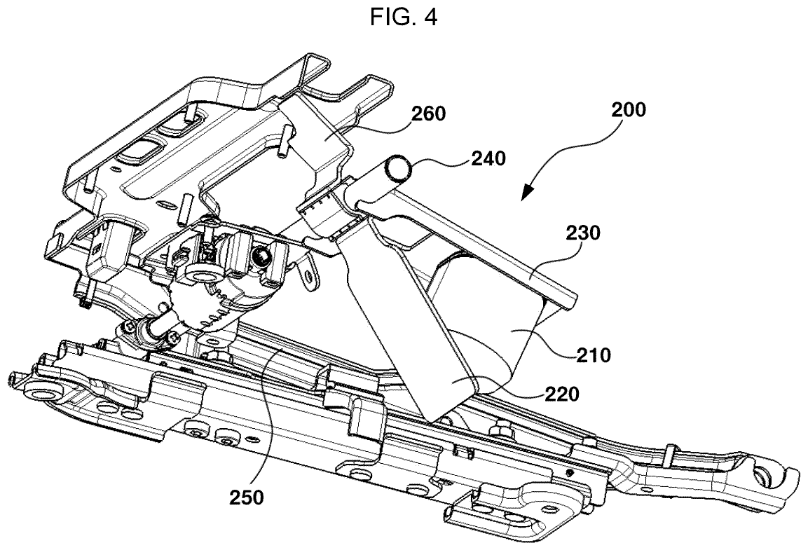

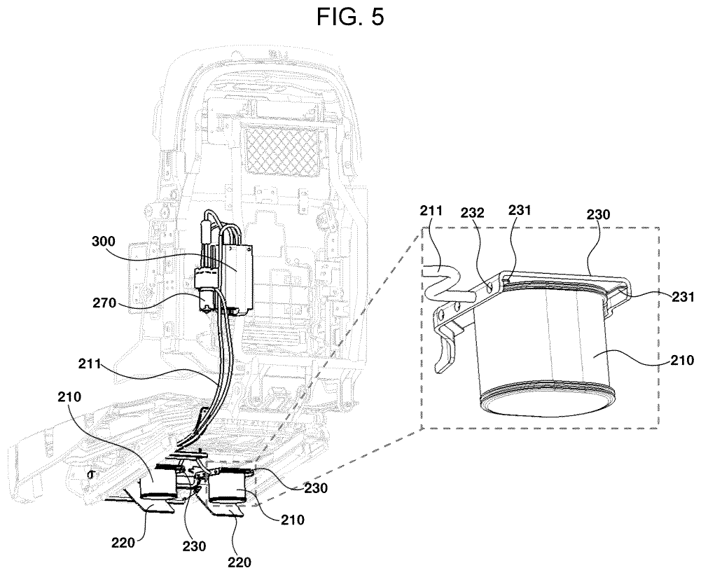

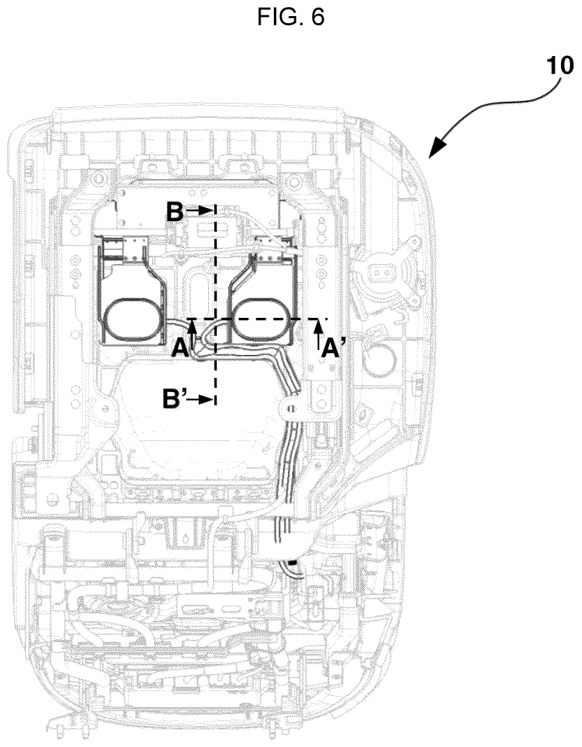

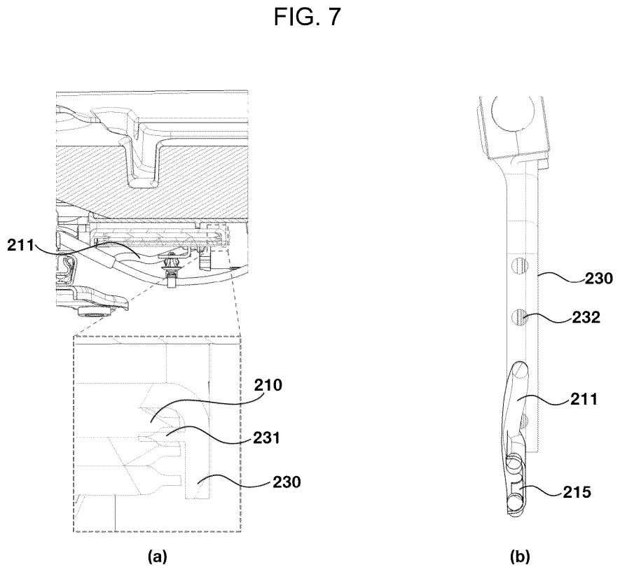

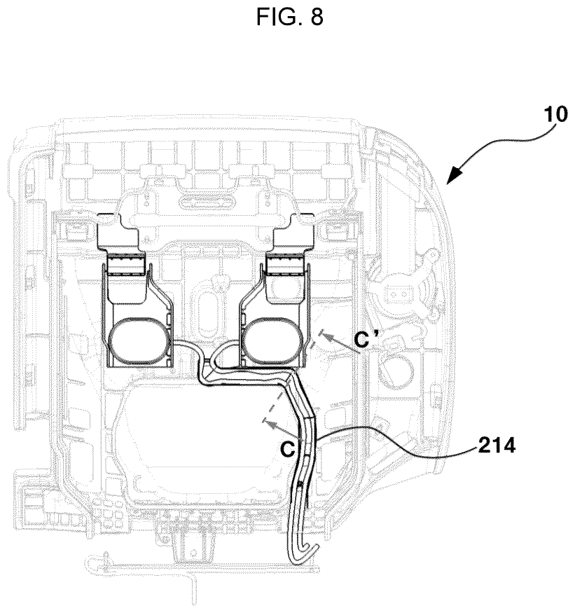

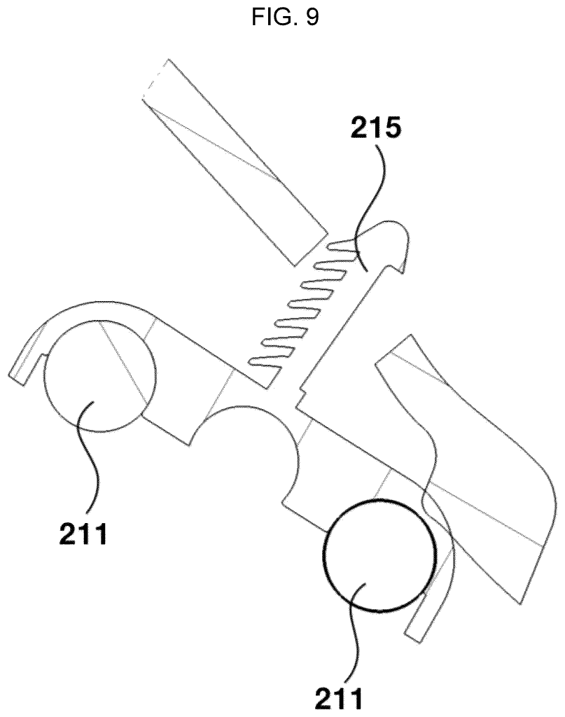

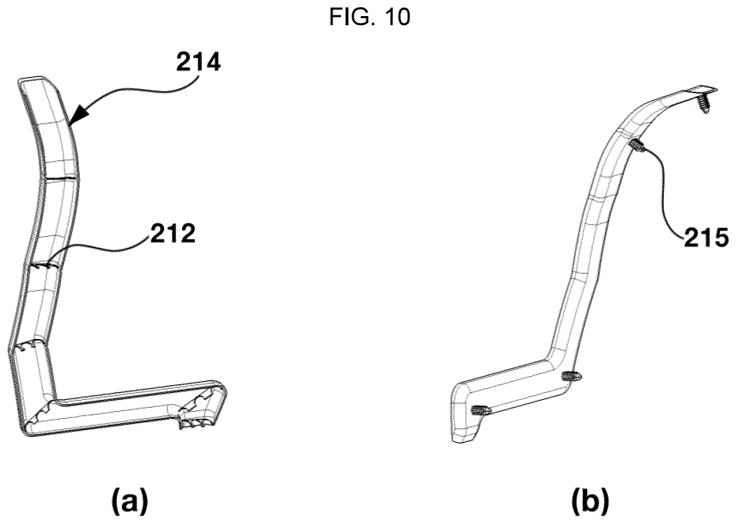

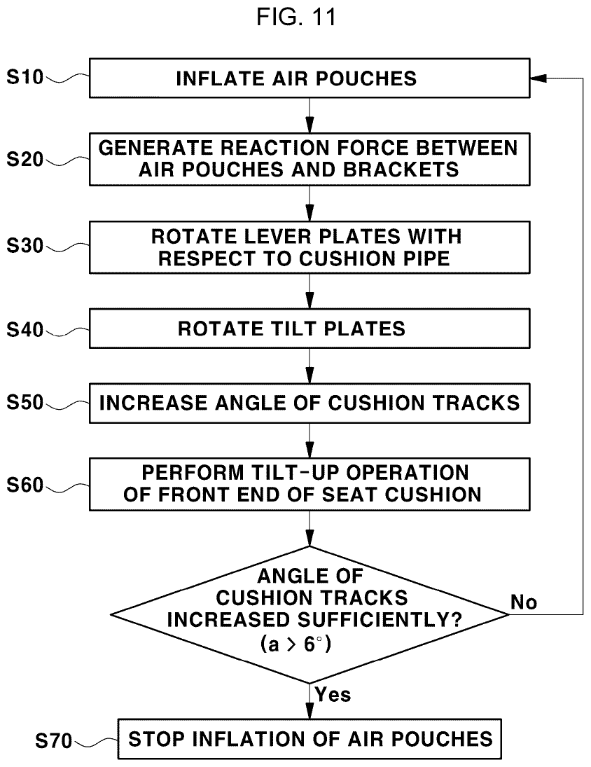

FIG. 2(a) is a perspective view of a vehicle seat according to the present disclosure before operation, FIG. 2(b) is a perspective view of the vehicle seat according to the present disclosure in a tilted state, FIG. 3(a) is a perspective view of a tilting unit of the present disclosure before operation, FIG. 3(b) is a perspective view of the tilting unit of the present disclosure in the tilted state, FIG. 4 is a bottom perspective view showing the tilting unit of the present disclosure in the tilted state, FIG. 5 is a perspective view illustrating in detail a state in which air pouches of the vehicle seat of the present disclosure are mounted on brackets, FIG. 6 is a bottom view showing the vehicle seat of the present disclosure before operation, FIG. 7(a) is a cross-sectional view taken along line A-A′ of FIG. 6, FIG. 7(b) is a cross-sectional view taken along line B-B′ of FIG. 6, FIG. 8 is a bottom view showing the vehicle seat of the present disclosure in the tilted state, FIG. 9 is a cross-sectional view taken along line C-C′ of FIG. 8, FIG. 10(a) is a view showing air hose ribs, FIG. 10(b) is a view showing fasteners, and FIG. 11 is a flowchart showing in detail a method of tilting the vehicle seat according to the present disclosure.

Referring to FIGS. 2 to 5, the present disclosure relates to a seat 10 installed in a vehicle, and the vehicle seat 10 includes a seat unit 100, a tilting unit 200, and a control unit 300.

First, the seat unit 100 of the present disclosure may include a seat formed of urethane foam used as a cushion that absorbs shock, and a cotton or leather material that wraps the urethane foam used as the cushion.

Further, the tilting unit 200 of the present disclosure is configured such that, as shown in FIG. 2(a), a seat cushion 120 of the seat unit 100 is located flat in normal times, and as shown in FIG. 2(b), the angle of the front end of the seat cushion 120 of the seat unit 100 may be changed by a control signal from the control unit 300.

The vehicle seat 10 according to one embodiment of the present disclosure includes the tilting unit 200 that adjusts the angle of the seat unit 100 depending on a passenger's selection. The tilting unit 200 of the present disclosure is configured to adjust the angle of the seat unit 100 depending on inflation or deflation of air pouches 210. Specifically, the tilting unit 200 includes the air pouches 210, lever plates 220, brackets 230, a cushion pipe 240, cushion tracks 250, tilt plates 260, and a pump 270, and is characterized in that the angle of the seat cushion 120 of the seat unit 100 is adjusted by operation of the above-described components.

First, each of the air pouches 210 of the tilting unit 200 according to one embodiment of the present disclosure has an internal space formed therein so that air may be suctioned into or exhausted from the internal space, and one or more air pouches 210 are provided to face each other. Specifically, the air pouches 210 may be formed of an elastic material for inflation or deflation, and the angle of the seat unit 100 may be adjusted depending on an amount of air supplied to the internal space. For example, the air pouches 210 may be provided such that, if a passenger wants to significantly change the angle of the front end of the seat cushion 120 of the seat unit 100, more air may be injected into the internal spaces of the air pouches 210 to rotate the front end of the seat cushion 120 upward at a larger angle. In addition, the air pouch 210 is located between the lever plate 220 and the bracket 230, which will be described later, and serves to space the lever plate 220 and the bracket 230 apart from each other to change the angle. As such, the amount of air supplied to the internal spaces of the air pouches 210 may be adjusted to change the seat 10 to a state that suits the passenger's preference.

In addition, air is supplied to the air pouches 210 by driving the pump 270, which will be described later, and the air pouches 210 is connected to air hoses 211 so that the air supplied from the pump 270 is stored in the internal spaces of the air pouches 210.

Next, the lever plate 220 of the tilting unit 200 according to one embodiment of the present disclosure is located on the bottom surface of the vehicle and coupled to the air pouch 210, and the angle of the lever plate 220 may be changed through inflation or deflation of the air pouch 210. The lever plate 220 coupled to the air pouch 210 is pushed downward through the operation of injecting air into the air pouch 210, and is coupled to the cushion pipe 240, which will be described later, to perform a function of lifting the tilt plate 260 coupled to the cushion pipe 240 upward. Further, the lever plate 220 is located at each of the air pouches 210, and operates at the same angle simultaneously so as to move the seat cushion 120 of the seat unit 100 upward in parallel. In addition, when the amount of air suctioned into the internal space of the air pouch 210 increases, the angle between the lever plate 220 and the bracket 230, which will be described later, may increase, a distance between the lever plate 220 and the bracket 230 may increase, and the front end of the seat cushion 120 may be raised higher upward.

Next, the bracket 230 of the tilting unit 200 according to one embodiment of the present disclosure is coupled to the air pouch 210, supports the inflation or deflation of the air pouch 210, is coupled to the bottom surface of the seat cushion 120 of the seat unit 100, and serves to stably support the lever plate 220 so that the angle of the lever plate 220 may be adjusted and to support the air pouch 210 so that the air pouch 210 may be inflated or deflated to a constant volume.

Further, the bracket 230 of the present disclosure includes bracket ribs 231 having a continuous step formed inwardly to fix the air pouch 210 and bracket holes 232 into which the air hoses 211 are inserted. Specifically, the bracket rib 231 of the bracket 230 has the continuous step formed in the direction of the air pouch 210, and at least one bracket rib 213 is located to face each other so that one surface of the air pouch 210 may be fitted into the inner surface of the bracket 230. As such, the air pouch 210 may be configured to be fitted into the at least one bracket rib 231 located to face each other so that any of air pouches 210 having various shapes may be installed in the bracket 230 and be easily attached to and detached from the bracket 230. In addition, the position of the air hose 211 of the air pouch 210 may be adjusted depending on the magnitude of the force required for tilting.

Next, the cushion pipe 240 of the tilting unit 200 according to one embodiment of the present disclosure serves as a hinge to which the brackets 230 are fixed and the lever plate 220 and the tilt plate 260, which will be described later, are fixed. Specifically, the cushion pipe 240 performs a function of moving the tilt plate 260 coupled to the cushion pipe 240, when the lever plate 220 moves. More specifically, since the lever plate 220 and the tilt plate 260 are coupled to the cushion pipe 240, when the lever plate 220 moves away from the air pouch 210, the tilt plate 260 coupled to the cushion pipe 240 rotates in one direction. On the contrary, when the lever plate 220 moves toward the air pouch 210, the tilt plate 260 coupled to the cushion pipe 240 rotates in the opposite direction to the above direction. Accordingly, the cushion pipe 240 serves as a hinge for the lever plate 220 and the tilt plate 260.

Next, the cushion tracks 250 of the tilting unit 200 according to one embodiment of the present disclosure are configured to move up or down when the air pouches 210 are inflated or deflated. Specifically, the cushion tracks 250 are coupled to the front end of the seat cushion 120 of the seat unit 100, and perform a function of moving the seat cushion 120 up or down depending on the air pressure of the air pouches 210 by a control signal from the control unit 300, which will be described later. In addition, when the cushion tracks 250 are lifted by the air pouches 210, the lever plate 220 is pushed by a reaction force, and the tilt plate 260 rotates in the opposite direction of the air intake direction of the air pouches 210 using the cushion pipe 240 as a hinge axis, thus lifting the cushion tracks 250.

Next, the tilt plates 260 of the tilting unit 200 according to one embodiment of the present disclosure are assembled to the cushion pipe 240 and perform a function of lifting the front end of the seat cushion 120 of the seat unit 100. Specifically, the tilt plate 260 of the present disclosure rotates in the opposite direction to the air intake direction of the air pouch 210 by the lever plate 220 coupled to the cushion pipe 240, thus serving to lift the cushion tracks 250.

Next, the pump 270 of the tilting unit 200 according to one embodiment of the present disclosure is configured such that the air hoses 211 are connected to the pump 270, and serves to move air to the air hoses 211 to supply air to the air pouches 210. In addition, the pump 270 is configured as a small pump, is located in a backrest 110 of the seat unit 100 adjacent to the control unit 300, and performs a function of injecting or exhausting air into or from the air pouches 210 depending on a control signal from the passenger.

The control unit 300 according to one embodiment of the present disclosure transmits a control signal to drive the tilting unit 200, and is provided so that, when the passenger inputs a control signal, the tilting unit 200 of the vehicle seat 10 connected to the control unit 300 may be driven. Here, the control unit 200 may be provided to determine air supply to or air exhaust from the air pouches 210 of the tilting unit 200, drive the pump 270, and determine the amount of air depending on the preferred seating posture of the passenger.

Further, the air pouches 210 of the tilting unit 200 according to one embodiment of the present disclosure are coupled to the air hoses 211, and each of the air pouches 210 includes air hose ribs 212, a rubber member 214, and fasteners 215.

Referring to FIGS. 5 to 10(b), at least one air hose 211 of the air pouch 210 according to one embodiment of the present disclosure extend between the air pouch 210 and the control unit 300, and is used as a flow path for injecting or exhausting air into or from the air pouch 210 by a control signal from the control unit 300. Specifically, the at least one air hose 211 is provided to inject or exhaust air into or from the air pouch 210, and in this case, the air hose 211 to which air will be supplied is determined depending on a signal from the control unit 300. In addition, as shown in FIG. 5, the air hoses 211 are configured to be located on the rear surface of the vehicle seat and be connected to the air pouches 210 via the pump 270. The air hoses 211 of the present disclosure may be provided to serve as the flow path of air, and may be provided as a rubber tube.

In addition, referring to FIGS. 5 and 7(b), the air hose 211 is inserted into the bracket hole 232 of the bracket 230. The number of the bracket holes 232 of the bracket 230 may be determined according to the number of the air hoses 211. In the present disclosure, in order to move the seat cushion 120 of the seat unit 100 parallel, it is described that one air hose 211 is connected to each of two air pouches 210, but in some embodiments, one or more air hoses 211 may be employed depending on the purpose or in order to increase the inflation strength of each air pouch 210. Accordingly, a corresponding number of bracket holes 232 of the bracket 230 may also be provided.

Referring to FIG. 10(a), the air hose ribs 212 of the air pouch 210 according to one embodiment of the present disclosure serve to fix the path of the air hose 211 so that the air hose 211 may be fixed without being removed.

Each of the air hose ribs 212 has holes formed therein, and the holes have an area corresponding to a cross-sectional area of the air hoses 211 so that the air hoses 211 are not easily removed, and is located in a curved part of the rubber member 214. The number of the holes formed in the air hose ribs 212 is determined depending on the number of the air hoses 211 fixed to the rubber member 214. In one embodiment of the present disclosure, two air hoses 211 respectively connected to two air pouches 210 are used to adjust the seat cushion 120 up and down. The number of the holes formed in the air hose ribs 212 is set to three, and the remaining hole may be used as an air hose path for another system, such as a pneumatic system for adjusting a leg rest up and down.

In addition, the rubber member 214 for the air pouches 210 according to one embodiment of the present disclosure is formed of Ethylene Propylene Diene M-Class Rubber (EPDM), is fixed to the cushion track 250, and serves to fix the path of the air hoses 211.

In addition, as shown in FIG. 10(b), the fasteners 215 for the air pouches 210 according to one embodiment of the present disclosure serve to fix the rubber member 214 to the cushion track 250.

FIG. 11 is a flowchart showing a method of tilting the vehicle seat according to the present disclosure in detail. Referring to FIG. 11, the method of tilting the vehicle seat according to one embodiment of the present disclosure will be described in detail.

First, air is supplied to or exhausted from the air pouches connected to the air hoses of the present disclosure to inflate or deflate the air pouches (S10). As the air pouches are inflated or deflated, a reaction force occurs between the brackets and the air pouches (S20). A distance between the lever plates and the brackets with respect to the cushion pipe increases by the inflation of the air pouches or decreases by deflation thereof, and the lever plates rotate (S30). Thereafter, the tilt plates coupled to the cushion pipe rotate (S40). The angle of the cushion tracks increases or decreases due to the rotation of the tilt plates (S50). Accordingly, the front end of the seat cushion coupled to the cushion tracks performs a tilt-up or tilt-down operation (S60). Thereafter, it is determined whether the angle of the cushion tracks has increased or decreased sufficiently and, after determining that the angle of the cushion tracks has increased or decreased at a predetermined angle or more, the inflation or deflation of the air pouches is stopped (S70). However, based on the determination that the angle of the cushion tracks is different from the predetermined angle, the air pouches are again inflated or deflated (S10).

As described above, a stable seating posture depending on the load of the body of a passenger using the air pressure of the air pouches of the tilting unit may be provided.

In addition, a small motor is employed as the motor for driving the seat unit, and the motor is installed in the backrest of the seat unit, thus being capable of utilizing the space where a number of parts couped to the motor were located.

In addition, the number of parts configured to drive the seat unit may be reduced, and the weight of the vehicle may be reduced, thus being capable of implementing a vehicle seat cushion capable of significantly improving energy efficiency.

In addition, a simple vehicle seat is implemented so that a controller and wiring work for driving a seat tilting device may be eliminated, thus allowing a work process of the seat unit to be performed quickly and improving workability.

Finally, a pneumatic system faster than the motor is implemented, thus being capable of securing seat stability of the vehicle and preventing the submarine phenomenon of a passenger from occurring in the event of a vehicle crash.

As is apparent from the above description, the present disclosure may obtain the following effects through the configuration and the combination and usage relations described in the above embodiments.

A vehicle seat according to the present disclosure may provide a stable seating posture depending on the load of the body of a passenger.

In addition, the present disclosure may reduce the number of parts configured to drive a seat cushion, and thus reduce the weight of a vehicle, thus enabling implementation of a vehicle seat cushion capable of improving the energy efficiency.

In addition, the present disclosure eliminates a controller and wiring work for driving a motor, thus allowing a work process of the seat cushion to be performed quickly and improving workability.

Finally, a pneumatic system faster than the motor is implemented, thus being capable of securing seat stability of the vehicle and preventing the submarine phenomenon of a passenger from occurring in the event of a vehicle crash.

The above detailed description is illustrative of the present disclosure. In addition, the above description is intended to illustrate the exemplary embodiments of the present disclosure, and the present disclosure may be used in various other combinations, modifications, and environments. That is, it should be apparent to those skilled in the art that various substitutions, changes and modifications which are not exemplified herein but are still within the spirit and scope of the present disclosure may be made. The described embodiments illustrate the best mode for implementing the technical idea of the present disclosure, and various changes required for specific application fields and uses of the present disclosure are also possible. Accordingly, the above detailed description of the disclosure is not intended to limit the present disclosure to the disclosed embodiments. In addition, the appended claims should be construed to include other embodiments.

What is claimed is:

1. A vehicle seat comprising:
a seat unit on which a passenger is to be seated;
a tilting unit assembled with the seat unit and configured to adjust an angle of the seat unit depending on a selection by a passenger; and
a control unit configured to transmit a control signal to the tilting unit and drive the tilting unit by the control signal,
wherein the tilting unit comprises air pouches and is configured to adjust the angle of the seat unit by allowing air to be injected into or exhausted from the air pouches by the control signal from the control unit.

2. The vehicle seat of claim 1, wherein the air pouches include an internal space so that air is supplied to or exhausted from the internal space, and include at least a pair of air pouches facing one another.

3. The vehicle seat of claim 1, wherein the tilting unit comprises:
a lever plate coupled to each of the air pouches such that an angle of the lever plate is adjustable depending on inflation or deflation of a corresponding one of the air pouches;
a bracket coupled to each of the air pouches and configured to support the inflation or deflation of a corresponding one of the air pouches;
a cushion pipe configured such that one end of the bracket and one end of the lever plate are coupled to the cushion pipe;
cushion tracks configured to be raised or lowered based on the air pouches being inflated or deflated;
tilt plates assembled with the cushion pipe and configured to lift the seat unit; and
a pump configured to supply air to the air pouches.

4. The vehicle seat of claim 3, wherein the bracket comprises:
bracket ribs including a continuous step formed inwardly to fix the corresponding one of the air pouches; and
bracket holes configured to accommodate air hoses inserted into the bracket holes.

5. The vehicle seat of claim 3, wherein each of the air pouches is coupled to one of a plurality of air hoses, and the plurality of air hoses extend between a corresponding one of the air pouches and the control unit and serve as flow paths configured to inject or exhaust air into or from the corresponding one of the air pouches by the control signal from the control unit.

6. The vehicle seat of claim 5, wherein each of the air hoses is coupled to the corresponding one of the air pouches so as to inject or exhaust air into or from the corresponding one of the air pouches.

7. The vehicle seat of claim 5, wherein each of the air pouches comprises:
air hose ribs configured to serve as guides configured to prevent the air hoses from being removed;
a rubber member coupled to the cushion track to fix a path of the air hoses; and
fasteners configured to fix the rubber member to the cushion track.

8. The vehicle seat of claim 7, wherein holes are formed in the air hose ribs, the air hoses are configured to be inserted into the holes, and a number of the holes is determined based on a number of the air hoses.

9. The vehicle seat of claim 7, wherein the holes formed in the air hose ribs are formed to have an area corresponding to a cross-sectional area of the air hoses.

10. The vehicle seat of claim 1, wherein the air pouches are capable of individually taking in and exhausting air so that an amount of air injected into an internal space of each of the air pouches is adjustable depending a desired degree of a passenger to control left-right balance of the seat unit.

11. A method of tilting a vehicle seat cushion comprising:
Inflating or deflating air pouches connected to air hoses;
generating a reaction force between the air pouches and brackets based on the air pouches being inflated;
changing an angle of lever plates coupled to a cushion pipe by inflating or deflating the air pouches;
allowing tilt plates coupled to the cushion pipe to rotate in an opposite direction to an air intake direction of the air pouch so as to lift or lower cushion tracks;
adjusting an angle of a front end of a seat unit by lifting or lowering the cushion tracks;
performing a tilt-up or tilt-down operation of the front end of the seat unit, and adjusting the angle of the front end of the seat unit such that an amount of air in the air pouches are determined and the angle of the front end is brought to a preferred angle of a passenger;
stopping injection or exhaust of air into the air pouches once the passenger is satisfied with an angle of the cushion tracks; and
determining whether the angle of the cushion tracks has been adjusted to an angle within a set range and returning to a step of inflating or deflating the air pouches in case the angle of the cushion tracks was not brought within the set range.
